(19) United States
(12) Patent Application Publication
(10) Pub. No.: US 2021/0187938 A1
(43) Pub. Date: Jun. 24, 2021

(54) INKJET RECORDING METHOD AND INKJET RECORDING APPARATUS

(71) Applicant: CANON KABUSHIKI KAISHA, Tokyo (JP)

(72) Inventors: Toru Ohnishi, Kanagawa (JP); Tsuyoshi Kanke, Kanagawa (JP); Sayoko Nagashima, Kanagawa (JP); Kanako Soma, Kanagawa (JP); Mikio Sanada, Kanagawa (JP); Satoshi Takebayashi, Tokyo (JP); Yuko Negishi, Tokyo (JP); Tetsuya Kosuge, Kanagawa (JP); Satoshi Kudo, Kanagawa (JP); Naofumi Shimomura, Kanagawa (JP); Ryo Taguri, Kanagawa (JP)

(21) Appl. No.: 17/120,577

(22) Filed: Dec. 14, 2020

(30) Foreign Application Priority Data
Dec. 23, 2019 (JP) 2019-231393

(51) Int. Cl. B41J 2/005

(52) U.S. Cl. CPC B41J 2/0057

(57) ABSTRACT

An inkjet recording method of the present disclosure is an inkjet recording method of recording an image on a recording medium using an aqueous ink. Coating wax on a transfer body; applying an aqueous reaction solution containing a reaction agent reacting with the aqueous ink to the transfer body; forming an intermediate image by applying the aqueous ink to the transfer body; and transferring the intermediate image by bringing the intermediate image into contact with the recording medium are included in this order, and a surface temperature Ta (° C.) of the transfer body at a position where the intermediate image contacts the recording medium, a surface temperature Tb (° C.) of the transfer body at a position where the intermediate image is separated from the transfer body and a melting point Tm (° C.) of the wax satisfy a relationship of Tb<Tm≤Ta.

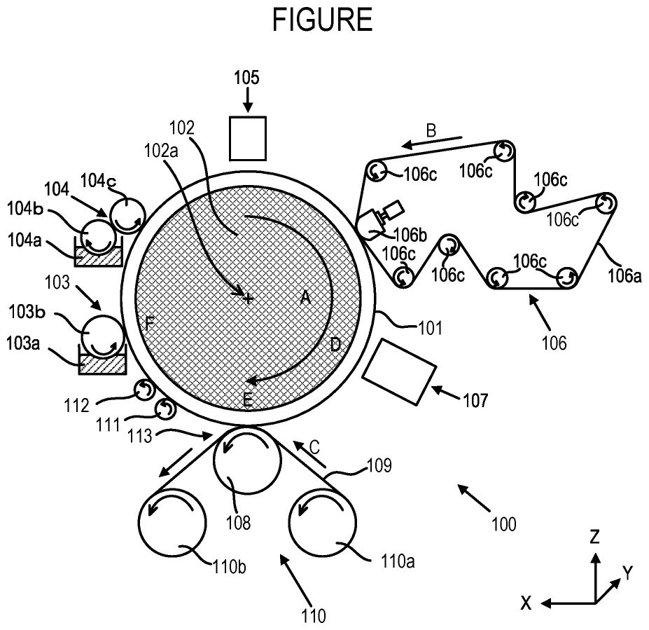

### BACKGROUND OF THE INVENTION

### Field of the Invention

The present disclosure relates to an inkjet recording method and an inkjet recording apparatus.

### Description of the Related Art

An aqueous ink is widely used as an ink used in an inkjet recording method. There is a so-called transfer type image recording method in which an ink image, which is an intermediate image, is formed on a transfer body and thereafter transferred to a recording medium to record an image.

For example, a recording method has been proposed in which a transfer belt to which a material such as polyethylene glycol whose wettability of ink changes depending on temperature is cooled and thereafter an ink is further applied (Japanese Patent Application Laid-Open No. 2009-214439). In addition, a direct recording method has been proposed in which a liquid composition containing wax particles and a component that agglomerates components in an ink is applied to a recording medium, and thereafter the ink is further applied to record an image (Japanese Patent Application Laid-Open No. 2016-060125).

### SUMMARY OF THE INVENTION

The present disclosure is intended to provide an inkjet recording method capable of recording an image having a high optical density while having excellent transferability of an image to a recording medium. In addition, the present disclosure is intended to provide an inkjet recording apparatus used in the inkjet recording method.

According to an aspect of the present disclosure, there is provided an inkjet recording method of recording an image on a recording medium using an aqueous ink, the method including coating wax on a transfer body; applying an aqueous reaction solution containing a reaction agent reacting with the aqueous ink to the transfer body; forming an intermediate image by applying the aqueous ink to the transfer body; and transferring the intermediate image by bringing the intermediate image into contact with the recording medium are included in this order, in which a surface temperature Ta (° C.) of the transfer body at a position where the intermediate image contacts the recording medium, a surface temperature Tb (° C.) of the transfer body at a position where the intermediate image is separated from the transfer body and a melting point Tm (° C.) of the wax satisfy a relationship of Tb<Tm≤Ta.

In addition, according to another aspect of the present disclosure, there is provided an inkjet recording apparatus used to record an image on a recording medium using an aqueous ink, the apparatus including a wax coating unit that coats wax on a transfer body; a reaction solution applying unit that applies an aqueous reaction solution containing a reaction agent reacting with the aqueous ink to the transfer body; an ink applying unit that forms an intermediate image by ejecting the aqueous ink by an inkjet method and applying the aqueous ink to the transfer body; a transfer unit that transfers the intermediate image by bringing the intermediate image into contact with the recording medium; and a temperature control unit that controls a temperature of the transfer body so that a surface temperature Ta (° C.) of the transfer body at a position where the intermediate image contacts the recording medium, a surface temperature Tb (° C.) of the transfer body at a position where the intermediate image is separated from the transfer body and a melting point Tm (° C.) of the wax satisfies a relationship of Tb<Tm≤Ta.

Further features of the present disclosure will become apparent from the following description of exemplary embodiments with reference to the attached drawing.

### BRIEF DESCRIPTION OF THE DRAWINGS

FIGURE is a schematic view illustrating an embodiment of an inkjet recording apparatus of the present disclosure.

### DESCRIPTION OF THE EMBODIMENTS

In the transfer type image recording method in the related art, the efficiency of transferring an intermediate image formed on a transfer body to a recording medium may be insufficient, such as poor transferability depending on the type of the recording medium. As a method of improving the transfer efficiency of the image to the recording medium, a method of raising the temperature of the intermediate image in a transfer step can be considered. However, as a result of the studies, it is found that when the temperature of the intermediate image in the transfer step is set high, a new problem such as a decrease in an optical density of the image transferred to the recording medium arises.

Therefore, the present inventors have made diligent studies in order to record an image having a high optical density while being excellent in transferability of the image to a recording medium, and have reached the present disclosure.

Hereinafter, the present disclosure will be described in more detail with reference to preferred embodiments. In the present disclosure, in a case where the compound is a salt, the salt dissociates into ions and exists in the ink, and for convenience, the case is expressed as “containing salt”. In addition, an aqueous reaction solution, an aqueous ink and an aqueous transfer accelerating solution for inkjet may be simply referred to as “reaction solution”, “ink” and “transfer accelerating solution”. The physical property values are values at room temperature (25° C.) unless otherwise specified. When described as “(meth) acrylic acid” and “(meth) acrylate”, these descriptions mean “acrylic acid, methacrylic acid” and “acrylate, methacrylate”, respectively.

In the case of a transfer type image recording method, it is preferable that most or all of the images formed on the transfer body are transferred to a recording medium, that is, the image has high transferability. In order to improve the transferability of the image to the recording medium, in the inkjet recording method of the present disclosure, wax is coated on the transfer body, and a wax layer that functions as a release layer when an intermediate image is transferred to the recording medium is formed in advance on the transfer body. Thereafter, in the transfer step, the intermediate image formed on the wax layer is brought into contact with the recording medium, the intermediate image is separated from the transfer body and the intermediate image is transferred to the recording medium. In the inkjet recording method of the present disclosure, a surface temperature Ta (° C.) of the transfer body at a position where the intermediate image contacts the recording medium and a melting point Tm (° C.) of the wax are controlled so as to satisfy the relationship of Tm≤Ta. As a result, the wax is in a molten state at the time of transfer, and the intermediate image is easily separated from the transfer body, so that the transferability of the image can be improved.

However, as a result of the studies, it was found that when the recording medium was separated from the transfer body while the wax was melted and the intermediate image was separated from the transfer body, the optical density of the intermediate image (image) transferred to the recording medium decreased. Since the wax in the molten state has a low viscosity, splitting is likely to occur in the wax layer when the recording medium is separated from the transfer body. Therefore, the unevenness generated by the splitting in the wax layer is formed on the surface of the image transferred to the recording medium. As a result, it is presumed that light is likely to be scattered on the surface of the image transferred on the recording medium, and the optical density of the image is lowered.

Therefore, the present inventors found that a surface temperature Tb (° C.) of the transfer body at a position where the intermediate image is separated from the transfer body and the melting point Tm (° C.) of the wax are controlled so as to satisfy the relationship of Tb<Tm. As a result, the viscosity of the wax when the intermediate image is separated from the transfer body is increased, and the splitting in the wax layer is suppressed. As a result, it is possible to suppress the occurrence of unevenness on the surface of the image transferred to the recording medium, and record an image with improved optical density.

<Inkjet Recording Method and Inkjet Recording Apparatus>

The inkjet recording method of the present disclosure (hereinafter, also simply referred to as “recording method”) is a method of recording an image on a recording medium using an aqueous ink. The recording method of the present disclosure includes a wax coating step, a reaction solution applying step, an intermediate image forming step and a transfer step in this order. The wax coating step is a step of coating wax on the transfer body, and the reaction solution applying step is a step of applying an aqueous reaction solution containing a reaction agent that reacts with the aqueous ink to the transfer body. The intermediate image forming step is a step of applying an aqueous ink to a transfer body to form an intermediate image, and the transfer step is a step of bringing the intermediate image into contact with a recording medium to transfer the intermediate image. That is, the recording method of the present disclosure is a transfer type inkjet recording method. The intermediate image forming step may further include, if necessary, a procedure of applying the aqueous ink to the transfer body and thereafter applying the aqueous transfer accelerating solution to the transfer body. If necessary, the recording method of the present disclosure may further include a cleaning step of applying an aqueous cleaning solution to the transfer body for cleaning.

In addition, the inkjet recording apparatus of the present disclosure (hereinafter, also simply referred to as “recording apparatus”) is an apparatus used for recording an image on a recording medium using the aqueous ink. The recording apparatus of the present disclosure is provided with a wax coating unit, a reaction solution applying unit, an ink applying unit, a transfer unit and a temperature control unit. The wax coating unit is a unit for coating wax on the transfer body, and the reaction solution applying unit is a unit for applying an aqueous reaction solution containing a reaction agent that reacts with the aqueous ink to the transfer body. The ink applying unit is a unit for ejecting an aqueous ink by an inkjet method and applying the aqueous ink to a transfer body to form an intermediate image, and the transfer unit is a unit for bringing the intermediate image into contact with a recording medium and transferring the intermediate image. Furthermore, the temperature control unit is a unit for controlling the temperature of the transfer body so as to satisfy the relationship of the following formula (A). That is, the recording apparatus of the present disclosure is a so-called transfer type inkjet recording apparatus. If necessary, the ink applying unit may include a unit for applying the aqueous transfer accelerating solution to the transfer body after applying the aqueous ink to the transfer body. The recording apparatus of the present disclosure may be further provided with a cleaning unit for cleaning the transfer body by applying an aqueous cleaning solution, if necessary.

Tb<Tm≤Ta (A)

Ta (° C.): Surface temperature of the transfer body at the position where the intermediate image contacts the recording medium

Tb (° C.): Surface temperature of the transfer body at the position where the intermediate image is separated from the transfer body

Tm (° C.): Melting point of wax

FIGURE is a schematic view illustrating an embodiment of the inkjet recording apparatus of the present disclosure. A transfer type inkjet recording apparatus 100 illustrated in FIGURE is an inkjet recording apparatus that prepares a recorded material by transferring an intermediate image to a recording medium 109 via a transfer body 101. An X direction, a Y direction and a Z direction indicate a width direction (total length direction), a depth direction and a height direction of the transfer type inkjet recording apparatus 100, respectively. The recording medium is conveyed in the X direction.

The transfer type inkjet recording apparatus 100 includes a transfer body 101, a wax coating device 103, a reaction solution applying device 104, an ink applying device 105, a liquid absorbing device 106, a heating device (temperature control device) 107 and a pressing member 108. The transfer body 101 is supported by a support member 102. The wax coating device 103 is a device that coats wax that functions as a release layer to facilitate separating the intermediate image from the transfer body 101 on the transfer body 101. The reaction solution applying device 104 is a device that applies a reaction solution containing a reaction agent that reacts with the ink to the transfer body 101 coated with wax. The ink applying device 105 is provided with a recording head that applies the ink to the transfer body 101 to which the reaction solution is applied to form an intermediate image. In a case where the transfer accelerating solution is used, the transfer accelerating solution is applied to the transfer body following the ink, and an intermediate image is formed. The liquid absorbing device 106 is a device that absorbs a liquid component from the intermediate image. The pressing member 108 is a member for transferring the intermediate image from which the liquid component is removed to a sheet-shaped recording medium 109 such as paper. Furthermore, the transfer type inkjet recording apparatus 100 may include a transfer body cleaning member 111 for cleaning the surface of the transfer body 101 after transfer. The transfer body 101, the wax coating device 103, the reaction solution applying device 104, the recording head of the ink applying device 105, the liquid absorbing device 106 and the transfer body cleaning member 111 each have a length corresponding only to the recording medium 109 used in the Y direction.

The transfer body 101 rotates in the direction of arrow A about a rotation axis 102a of the support member 102. After the wax is coated on the rotating transfer body 101 from the wax coating device 103, the reaction solution is applied from the reaction solution applying device 104 and the ink is further applied from the ink applying device 105. In this manner, an intermediate image is formed on the wax layer of the transfer body 101. The intermediate image moves to a position where the intermediate image comes into contact with a liquid absorbing member 106a of the liquid absorbing device 106 by the rotation of the transfer body 101.

The liquid absorbing member 106a constituting the liquid absorbing device 106 moves (rotates) in the direction of the arrow B in synchronization with the rotation of the transfer body 101. The intermediate image comes into contact with the moving liquid absorbing member 106a. Meanwhile, the liquid absorbing member 106a absorbs and removes the liquid component from the intermediate image. From the viewpoint of efficiently absorbing the liquid component of the intermediate image, it is preferable that the liquid absorbing member 106a is pressed against the transfer body 101 with a predetermined pressing force. The intermediate image is formed of an ink, a transfer accelerating solution (used as necessary) and a reaction solution. Therefore, the description of absorbing the liquid component of the intermediate image means absorbing the liquid component in the ink, the transfer accelerating solution (used as necessary) and the reaction solution. It can be said that absorbing the liquid component from the intermediate image means concentrating the ink. Concentration of ink increases the ratio of solids such as a coloring material and a resin to the liquid component.

The intermediate image in which the liquid component is removed and the ink is concentrated is heated by the rotation of the transfer body 101 through the position heated by the heating device 107. Thereafter, the intermediate image moves to a transfer portion 113 in contact with the recording medium 109 conveyed by a recording medium conveying device 110. The intermediate image and the recording medium 109 are pressed from the pressing member 108 side and come into contact with each other while being sandwiched between the transfer body 101 and the pressing member 108. In a case where the transfer body 101 formed without including the elastic material and the columnar pressing member 108 are used, the intermediate image and the recording medium 109 come into linear contact with each other along the Y direction. When the transfer body 101 formed of the elastic material and the columnar pressing member 108 are used, the transfer body 101 is recessed by the pressing, so that the intermediate image and the recording medium 109 come into contact with each other on the surface. Therefore, one of the line and the surface where the intermediate image and the recording medium 109 come into contact with each other is referred to as a “region”, and the portion including this region is referred to as the transfer portion 113. While the intermediate image is in contact with the recording medium 109, the pressing member 108 presses the transfer body 101 to transfer the intermediate image to the recording medium 109, and a desired image is recorded on the recording medium 109. The image after transfer is an inverted image of the intermediate image before transfer.

When the reaction solution is applied to the transfer body by using a roller-shaped reaction solution applying member 104c, the reaction solution is applied to the entire transfer body. Since an ink is applied to the transfer body to which the reaction solution is applied to form an intermediate image, the reaction solution not reacted with the ink remains in the region of the transfer body to which the ink is not applied. The liquid absorbing member 106a can remove not only the liquid component from the intermediate image but also the liquid component of the unreacted reaction solution. The liquid component contained in one of the ink and the reaction solution does not have a certain shape, has fluidity and exists in a substantially constant volume. Specifically, the liquid component contained in one of the ink and the reaction solution is an aqueous medium.

Hereinafter, [1] the transfer body, [2] the support member, [3] the wax coating device, [4] the reaction solution applying device, [5] the ink applying device [6] the liquid absorbing device, [7] the heating device (temperature control device), [8] the pressing member for transfer, [9] the recording medium, [10] the recording medium conveying device and [11] the cleaning device, which are the main parts of the transfer type inkjet recording apparatus, will be described.

[1] Transfer Body

The transfer body 101 has a surface layer on which an intermediate image is formed. The surface layer is preferably made of a material having a low affinity for wax that functions as a release layer in order to improve the transferability of the intermediate image to the recording medium. When the intermediate image is transferred and the intermediate image and the recording medium are configured to be in surface contact with each other, a nipped state can be maintained. During that time, the wax layer and the intermediate image are efficiently heated, and the transferability can be improved. Therefore, the transfer body is preferably elastic. The transfer body having elasticity may be one provided with a surface layer formed of an elastic material, and may be one provided with an elastic layer formed of an elastic material separately from the surface layer.

Examples of the material constituting the surface layer include an elastomer material such as a natural rubber and a synthetic rubber; a polyolefin resin such as polyethylene and polypropylene; a polyester resin such as polyethylene terephthalate; a polyimide resin; various modified products of these materials (siloxane modification). Among these, resins having a siloxane structure (silicone rubber and siloxane-modified resins other than silicone rubber) are preferable. In a case where an infrared heater is used as the heating device described later, when an infrared absorbing material such as carbon black is mixed with the material constituting the surface layer, the irradiated infrared rays are easily converted into heat, so that the heating efficiency can be improved.

Examples of the material constituting the elastic layer include elastomers such as a natural rubber and a synthetic rubber; and various modified products thereof. Among these, silicone rubber, fluorosilicone rubber, phenylsilicone rubber are preferable.

The transfer body may further have a reinforcing layer made of a material having a high compressive elastic modulus such as a woven fabric in order to suppress lateral elongation and maintain elasticity when mounted on the support member. Each of the layers (surface layer, elastic layer and reinforcing layer) constituting the transfer body can be adhered to each other by using one of an adhesive and a double-sided tape. The size of the transfer body can be freely selected according to the recording speed and the size of the image. Examples of the shape of the transfer body include a sheet shape, a roller shape, a belt shape, an endless web shape.

[2] Support Member

The transfer body 101 is supported on the support member 102. The transfer body can be disposed on a support body by using, for example, one of an adhesive and a double-sided tape. The transfer body 101 may be disposed on the support member 102 by using an installation member made of a material such as metal, ceramic and resin. The support member 102 is required to have a certain level of structural strength from the viewpoint of conveyance accuracy and durability. Examples of the material of the support member include metal, ceramic and resin. Among these, it is preferable to use a metal material such as aluminum. By using the metal material, it is possible to improve the responsiveness of control by reducing the inertia during operation as well as the rigidity and dimensional accuracy that can withstand the stress during transfer.

[3] Wax Coating Device

The transfer type inkjet recording apparatus 100 illustrated in FIGURE includes a wax coating device 103 which is a unit for coating wax on the transfer body 101. The wax is coated on the transfer body 101 by the wax coating device 103 so as to overlap at least a portion of the region to which the ink is applied. As a result, a wax layer can be formed on the surface of the transfer body. The wax layer is preferably formed over the entire region corresponding to the recording medium. The wax coating device 103 is provided with a wax accommodating portion 103a for accommodating wax, and a wax coating member 103b for coating wax on the transfer body 101. The wax accommodating portion 103a may be provided with a heating mechanism (not illustrated) for heating and melting the wax accommodating therein. The heating temperature may be a temperature at which the wax can be liquefied, that is, equal to or higher than the melting point of the wax. Specifically, it is preferably 40° C. or higher to 150° C. or lower, and more preferably 50° C. or higher to 120° C. or lower. The wax coating device 103 illustrated in FIGURE is an example using a bar coater. Examples of the wax coating device include a gravure roller, an offset coater, a bar coater, a die coater, a blade coater, a knife coater and a device using at least two combinations thereof. Among these, it is preferable to coat wax on the transfer body using a roller. In a case where the wax is coated on the transfer body using a roller, the wax is uniformly coated on the region corresponding to the recording medium unless special measures are taken.

The surface layer of the transfer body 101 is preferably made of a material having a low affinity for wax in order to improve the transferability of the intermediate image to the recording medium. However, when the surface layer of the transfer body is made of a material having a low affinity for wax, it may be difficult to form a thin wax layer because the wax is repelled and is difficult to wet and spread. In order to efficiently form a thin wax layer, it is preferable to coat a liquid wax on a transfer body having a temperature lower than the melting point of the wax and change the state of the wax in contact with the transfer body from a liquid to a solid. As a result, the wax is unlikely to be repelled by the transfer body, and a thin wax layer can be formed on the surface of the transfer body. The thickness of the wax layer formed on the surface of the transfer body is preferably 0.1 μm or more to 10.0 μm or less, more preferably 0.1 μm or more to 5.0 μm or less and particularly preferably 0.2 μm or more to 5.0 μm or less. The thickness of the wax layer can be controlled by, for example, the following method. For example, in a case where a bar coater is used as a wax coating member for coating wax on a transfer body, the thickness of the formed wax layer can be controlled by controlling the wire diameter and the contact pressure.

The following method can be described as a method of efficiently forming a thin wax layer by coating a liquid wax on a transfer body having a temperature lower than the melting point of the wax and changing the state of the wax in contact with the transfer body from a liquid to a solid. That is, there are methods such as (1) coating a liquid wax at room temperature (25° C.) on a transfer body having a temperature lower than the melting point of the wax; and (2) heating and melting a solid wax at room temperature (25° C.) into a liquid, and coating the liquid wax on a transfer body having a temperature lower than the melting point of the wax. The transfer body and the wax coating member may be heated or cooled according to the characteristics of the wax to be coated. The temperature of the transfer body and the wax coating member can be controlled by using one of an internal and an external temperature control unit (heating device and cooling device). In addition, the temperature may be controlled by one of contact and non-contact using a composition used for recording such as a reaction solution, an ink and a recording medium and other members constituting the recording apparatus, and the temperature may be controlled by natural heat dissipation.

In the wax coating device 103 illustrated in FIGURE, the wax contained in the wax accommodating portion 103a is heated to a melting point or higher by a heating mechanism (not illustrated) to melt the wax. The wax coating member 103b holds the wax in a liquid state, and the wax is coated on the transfer body 101 having a temperature lower than the melting point of the wax. The wax accommodating portion 103a and the wax coating member 103b are held at a temperature of the melting point of the wax or higher so that the wax does not solidify. The temperature of the wax before being coated on the transfer body is substantially the same as the temperature at the position where the wax coating member comes into contact with the transfer body. Therefore, when the temperature of the wax coating member is controlled, the temperature of the wax when the wax is coated on the transfer body can be grasped. The surface temperature T_{R} (° C.) of the wax coating member (temperature at the position in contact with the transfer body (position illustrated by “F” in)) is preferably the melting point Tm (° C.) of the wax or higher, and more preferably 5° C. or higher to 40° C. or lower, which is the melting point Tm (° C.) of the wax.

The temperature of the wax after being applied to the transfer body is substantially the same as the temperature at the position where the transfer body comes into contact with the wax coating member. Therefore, when the temperature of the transfer body is controlled, the temperature of the wax coated on the transfer body can be grasped. It is preferable that the surface temperature TT (° C.) of the transfer body (temperature at the position where the transfer body contacts the wax coating member (position illustrated by “F” in FIGURE)) and the melting point Tm (° C.) of the wax satisfy the relationship of the following formula (1). In addition, it is preferable that the surface temperature TT (° C.) of the transfer body and the melting point Tm (° C.) of the wax satisfy the relationship of the following formula (2). The temperature of the wax coating member and the transfer body at the positions where the wax coating member and the transfer body come into contact with each other can be measured with a non-contact thermometer.

TT<Tm (1)

(Tm−40)≤TT≤(Tm−15) (2)

[4] Reaction Solution Applying Device

The recording method of the present disclosure includes a reaction solution applying step of applying an aqueous reaction solution to the transfer body coated with wax before the intermediate image forming step. The reaction solution contains a reaction agent that reacts with the ink when the reaction agent comes into contact with the ink and aggregates components having anionic groups such as a resin and a self-dispersion pigment in the ink. After applying the ink, the reaction solution may be further applied so that at least a portion of the region to which the ink is applied overlaps.

The transfer type inkjet recording apparatus 100 illustrated in FIGURE includes a reaction solution applying device 104 which is a reaction solution applying unit for applying the reaction solution to the transfer body 101. The reaction solution applying device 104 includes a reaction solution accommodating portion 104a for accommodating the reaction solution, a reaction solution supply member 104b for supplying the reaction solution contained therein to the reaction solution applying member 104c and the reaction solution applying member 104c for applying the reaction solution to the transfer body 101. That is, the reaction solution applying device 104 illustrated in FIGURE is a gravure offset roller. Examples of the reaction solution coating device include an inkjet recording head, a bar coater, a die coater, a blade coater and a knife coater, in addition to the gravure offset roller. Among these, it is preferable to apply the reaction solution to the transfer body using a roller.

[5] Ink Applying Device

The transfer type inkjet recording apparatus 100 illustrated in FIGURE includes an ink applying device 105 which is an ink applying unit for applying an ink to the transfer body 101. It is preferable to use an inkjet recording head as an ink applying device to eject and apply the ink. Examples of the recording head include a form in which an electric-heat converter causes a film to boil in the ink and forms air bubbles to eject the ink; a form in which ink is ejected by an electric-mechanical converter; and a form in which ink is ejected using static electricity. Among these, a recording head in the form of using an electric-heat converter is preferable because the recording head can record a high-speed and high-density image.

The recording head is a full-line head extending in the Y direction, and the ejection orifices are arranged in a range covering the width of the image recording region of the maximum usable recording medium. The recording head has an ejection orifice surface having the ejection orifice open on the lower surface thereof (transfer body 101 side). The ejection orifice surface faces the surface of the transfer body 101 with a minute gap (approximately several millimeters).

The ink applying device 105 may have a plurality of recording heads in order to apply the ink of each color such as cyan, magenta, yellow and black (CMYK) to the transfer body 101. For example, in a case of forming an intermediate image using four types of CMYK inks, the ink applying device has four recording heads for ejecting each of the four types of CMYK inks. These recording heads are disposed along the X direction.

In addition to the inks of each color containing coloring materials such as cyan, magenta, yellow and black, a liquid (transfer accelerating solution) for accelerating the transfer of the intermediate image to the recording medium can be applied to the transfer body. The unit for applying the transfer accelerating solution to the transfer body is not particularly limited, and it is preferable to use an inkjet recording head as in the case of ink to eject the transfer accelerating solution and apply the transfer accelerating solution to the transfer body. That is, the ink applying device 105 may include a unit for applying the transfer accelerating solution to the transfer body. The region for applying the transfer accelerating solution to the transfer body preferably includes at least a region for applying the ink. That is, it is preferable to superimpose the ink and the transfer accelerating solution and apply these to the transfer body.

The region for applying the transfer accelerating solution to the transfer body is preferably wider than the region for applying the ink. By causing the region to which the transfer liquid is applied wider than the region to which the ink is applied, it is possible to improve the scratch resistance of the recorded image. When the transfer accelerating solution is used, an image including a laminated region in which a layer formed of the transfer accelerating solution (transfer accelerating solution layer) and a layer formed of the ink (ink layer) are laminated is recorded. When a height difference between the laminated region and the region other than the non-recording region is large, in a case where the recording surfaces (surfaces on which images are recorded) of the recording medium are rubbed against each other, the edges of the image are likely to be caught by each other and the scratch resistance of the image may decrease. On the other hand, when the region to which the transfer liquid is applied is wider than the region to which the ink is applied, the region of only the transfer accelerating solution layer is formed, so that the boundary between the image and the non-recording region is smoothed. Therefore, even in a case where the recording surfaces of the recording medium are rubbed against each other, the edges of the image are unlikely to be caught by each other, and the scratch resistance of the image can be improved.

[6] Liquid Absorbing Device

The liquid absorbing device 106 includes a liquid absorbing member 106a and a pressing member 106b for liquid absorbing that presses the liquid absorbing member 106a against the intermediate image of the transfer body 101. In a case where the pressing member 106b and the belt-shaped liquid absorbing member 106a are formed, the liquid component can be absorbed from the intermediate image by pressing the liquid absorbing member 106a against the transfer body 101 with the pressing member 106b. In addition, the liquid component can be absorbed from the intermediate image by pressing the pressing member having the liquid absorbing member attached to the outer peripheral surface against the transfer body. Considering the space in the recording apparatus, the shape of the liquid absorbing member 106a is preferably a belt shape. The liquid absorbing device 106 having the belt-shaped liquid absorbing member 106a may have a stretching member such as a stretching roller 106c that stretches the liquid absorbing member 106a.

By bringing the liquid absorbing member 106a including a porous layer into contact with the intermediate image using the pressing member 106b, the liquid component contained in the intermediate image can be absorbed by the liquid absorbing member 106a. As a method of absorbing the liquid component contained in the intermediate image, a method of heating, a method of blowing low humidity air and a method of reducing the pressure may be combined, in addition to the method of contacting the liquid absorbing member. In addition, these methods may be applied to the intermediate images before and after absorbing the liquid component.

The liquid absorbing member 106a rotates in conjunction with the rotation of the transfer body 101. Therefore, the shape of the liquid absorbing member 106a is preferably a shape capable of repeatedly absorbing liquid, and specific examples thereof include an endless belt shape and a drum shape. The liquid component absorbed by the liquid absorbing member 106a including the porous layer can be removed from the liquid absorbing member 106a by a method of absorbing from the rear surface of the porous layer and a method of using a member that squeezes by compressing the porous layer. After removing the liquid component, the liquid absorbing member 106a is rotated to bring the liquid absorbing member 106a into contact with the new intermediate image, so that the liquid component contained in the intermediate image can be efficiently absorbed.

[7] Heating Device (Temperature Control Device)

The heating device 107 is a heating unit for heating the intermediate image. By heating the intermediate image, at least a portion of the liquid component contained in the intermediate image can be evaporated and removed, and the components (wax and resin particles) contained in the intermediate image can be softened. By transferring the intermediate image to the recording medium 109 after removing at least a portion of the liquid component, curling and cockling of the recording medium 109 can be suppressed more effectively.

Examples of the heating method include a method of heating from the front surface direction of the intermediate image; a method of heating from the rear surface direction of the intermediate image; and a method of combining these methods. The heating unit may be either a contact type or a non-contact type. Examples of the heating units include a non-contact heating mechanism such as a hot air heating mechanism using a dryer, a radiation heating mechanism using one of a halogen heater and an infrared heater and a heating mechanism by electromagnetic induction; and a contact heating mechanism such as a hot pressure heating mechanism by an iron press. Among these, from the viewpoint of heating efficiency, a radiant heating mechanism using an infrared heater is preferable.

The heating temperature of the intermediate image by the heating device may be set so that the intermediate image has a desired temperature. The heating temperature of the intermediate image is substantially the same as the temperature of the transfer body at the heating position (position illustrated by “D” in FIGURE). Therefore, when the temperature of the transfer body is controlled, the heating temperature of the intermediate image can be grasped. The surface temperature (° C.) of the transfer body at the heating position (temperature at the position illustrated by “D” in FIGURE) is preferably 80° C. or higher to 150° C. or lower, and more preferably 100° C. or higher to 130° C. or lower. The surface temperature of the transfer body at the heating position can be measured with a non-contact thermometer.

The heating by the heating device 107 can be used to control the temperature suitable for melting at least a portion of the wax when transferring the intermediate image to the recording medium. In addition, the heating by the heating device 107 can also be used to control the surface temperature of the transfer body to a temperature suitable for changing the state of the wax to be coated from a liquid to a solid. The heating temperature may be appropriately set in consideration of the temperature drop due to heat dissipation. Therefore, the heating device 107 is also a temperature control unit for controlling the temperature of the transfer body. For example, the surface temperature Ta (° C.) of the transfer body at the position where the intermediate image contacts the recording medium can be controlled by the heating device 107, which is a specific example of the temperature control device (temperature control unit).

[8] Pressing Member for Transfer

The recording apparatus of the present disclosure is provided with a transfer unit for transferring the intermediate image in contact with the recording medium. Specifically, as illustrated in FIGURE, the intermediate image after removing the liquid on the transfer body 101 is brought into contact with the recording medium 109 conveyed by the recording medium conveying device 110 by the pressing member 108 for transfer at the transfer portion 113 and transferred. The intermediate image is transferred to the recording medium 109 by passing through a nip portion between the transfer body 101 and the pressing member 108 in a state where the intermediate image on the transfer body 101 faces the recording medium 109. Since the wax layer has a low affinity for the transfer body, the wax layer serves as a release layer for facilitating the separation of the transfer body and the intermediate image, and the intermediate image can be efficiently transferred to the recording medium. Wax is present on at least a portion of the surface of the image transferred to the recording medium.

In the recording method of the present disclosure, the surface temperature Ta (° C.) of the transfer body at the position where the intermediate image contacts the recording medium is set to a temperature of the melting point Tm (° C.) of the wax or higher. As a result, at least a portion of the wax is melted to improve the releasability and the transferability. In addition, it is preferable that the surface temperature Ta (° C.) of the transfer body and the melting point Tm (° C.) of the wax satisfy the relationship of Ta−Tm≥10 (° C.). By controlling the surface temperature Ta (° C.) of the transfer body and the melting point Tm (° C.) of the wax so as to satisfy the above relationship, the transferability can be further improved.

Furthermore, in the recording method of the present disclosure, the surface temperature Tb (° C.) of the transfer body at the position where the intermediate image is separated from the transfer body is set to a temperature lower than the melting point Tm (° C.) of the wax. As a result, at least a portion of the wax is cured, so that the unevenness of the transferred image surface is suppressed, and the image density can be improved. In addition, it is preferable that the surface temperature Tb (° C.) of the transfer body and the melting point Tm (° C.) of the wax satisfy the relationship of Tm−Tb≥20 (° C.). The image density can be further improved by controlling the surface temperature Tb (° C.) of the transfer body and the melting point Tm (° C.) of the wax so as to satisfy the above relationship. The unit (temperature control unit) and method of controlling the surface temperature Tb (° C.) of the transfer body at the position where the intermediate image is separated from the transfer body are not particularly limited. For example, the surface temperature Tb (° C.) of the transfer body can be controlled by using a temperature control device inside or outside the transfer body. In addition, the surface temperature Tb (° C.) of the transfer body may be controlled by contact or non-contact using other members constituting the recording apparatus, and the surface temperature Tb (° C.) of the transfer body may be controlled by one of natural heat dissipation and contact with a recording medium.

The pressing member 108 preferably has an appropriate structural strength from the viewpoint of conveyance accuracy and durability of the recording medium 109. Examples of the material of the pressing member 108 include metal, ceramic and resin. Among these, a metal such as aluminum is preferable from the viewpoint of not only having rigidity and dimensional accuracy that can withstand stress during transfer, but also reducing inertia during operation and improving control responsiveness. Examples of the shape of the pressing member 108 include a roller shape.

When the intermediate image is transferred to the recording medium 109, the time for the pressing member 108 to press the transfer body 101 (pressing (nip) time) is preferably 5 milliseconds or more to 100 milliseconds or less. By setting the pressing time as described above, transfer can be performed satisfactorily and damage to the transfer body 101 can be suppressed. The pressing time is the time during which the recording medium 109 and the transfer body 101 are in contact with each other. The pressing time can be calculated by measuring the surface pressure using a pressure distribution measuring system and dividing the length of the pressurized region in the conveyance direction by the conveyance speed. Specifically, a surface pressure distribution measurement system (trade name “I-SCAN”, manufactured by Nitta Corporation) can be used.

When the intermediate image is transferred to the recording medium 109, the pressure (pressing force) at which the pressing member 108 presses the transfer body 101 is 9.8 N/cm² (1 kg/cm²) or more to 294.2 N/cm² (30 kg)/Cm²) or less is preferable. By applying the above pressing force, transfer can be performed satisfactorily and damage to the transfer body 101 can be suppressed. The pressing force is a nip pressure of the recording medium 109 and the transfer body 101. The pressing force can be calculated by measuring the surface pressure using a pressure distribution measuring system and dividing the load in the pressurized region by the area. Specifically, a surface pressure distribution measurement system (trade name “I-SCAN”, manufactured by Nitta Corporation) can be used.

The temperature of the intermediate image at the position where the pressing member 108 presses the transfer body 101 is preferably a temperature of the glass transition point (or softening point) or higher of the resin component contained in the intermediate image. The temperature of the intermediate image is substantially the same as the temperature of the transfer body at the transfer position (position illustrated by “E” in FIGURE). Therefore, when the temperature of the transfer body is controlled, the temperature of the intermediate image can be grasped. The surface temperature Ta (° C.) of the transfer body at the position where the intermediate image contacts the recording medium at the transfer position (position illustrated by “E” in FIGURE) is preferably 60° C. or higher to 140° C. or lower, and more preferably 70° C. or higher to 120° C. or lower. The surface temperature Tb (° C.) of the transfer body at the transfer position (position illustrated by “E” in FIGURE) at the position where the intermediate image is separated from the transfer body is preferably 50° C. or higher to 130° C. or lower, and more preferably 60° C. or higher to 110° C. or lower. The surface temperatures Ta and Tb of the transfer body can be measured with a non-contact thermometer.

[9] Recording Medium

As the recording medium 109, any known recording medium can be used. Examples of the recording medium include a long object wound in a roll shape; and a single sheet cut into a predetermined size. Examples of the constituent material of the recording medium include paper such as coated paper and plain paper; film such as plastic and metal; wooden board; and corrugated cardboard.

[10] Recording Medium Conveying Device

The recording medium conveying device 110 that conveys the recording medium 109 conveys the recording medium 109 in the direction of arrow C. The recording medium conveying device 110 includes a recording medium feeding roller 110a and a recording medium winding roller 110b. The conveyance speed of the recording medium 109 is preferably determined in consideration of the speed required in each step.

[11] Cleaning Device

As illustrated in FIGURE, it is preferable that the recording apparatus of the present disclosure is further provided with a cleaning device which is a cleaning unit for applying an aqueous cleaning solution to the transfer body 101 for cleaning. The cleaning device is provided with, for example, a transfer body cleaning member 111 that applies a cleaning solution to the transfer body 101 for cleaning. By cleaning the transfer body 101 with the transfer body cleaning member 111, deterioration of image quality can be suppressed. As the transfer body cleaning member 111, a member having a shape such as a roller and a web can be used. The cleaning device may be provided with a cleaning solution supply unit that supplies the cleaning solution to the transfer body cleaning member 111.

Furthermore, it is preferable that the cleaning device is provided with a cleaning solution removing member 112 that removes the cleaning solution remaining on the transfer body 101 after cleaning. By removing the cleaning solution remaining on the transfer body 101 by the cleaning solution removing member 112, deterioration of image quality can be suppressed more effectively. Examples of the method of removing the cleaning solution remaining on the transfer body 101 include blade removal, brush removal and liquid absorption by an absorber. Among these, it is preferable to remove the cleaning solution remaining on the transfer body 101 by the liquid absorption by the absorber.

(Wax)

The recording method of the present disclosure includes a wax coating step of coating the wax on the transfer body. The wax layer formed by coating the wax on the transfer body serves as a release layer for facilitating the separation of the intermediate image from the transfer body. The wax may be a composition containing one of components other than the wax, and the wax itself. Among these, it is preferable to coat the wax itself on the transfer body, which does not substantially contain components other than the wax.

In a narrow sense, the wax is an ester of a higher monohydric or divalent alcohol insoluble in water and a fatty acid, includes animal-based wax and vegetable-based wax and does not contain fats and oils. In a broad sense, the wax includes high melting point fats, mineral-based waxes, petroleum-based waxes and blends or modifications of various waxes. In the recording method of the present disclosure, any wax in a broad sense can be used without particular limitation. Waxes in a broad sense can be classified into natural waxes, synthetic waxes, blends thereof (blended waxes) and modifications thereof (modified waxes).

Examples of the natural waxes include animal-based waxes such as beeswax, whale wax and wool wax (lanolin); vegetable-based waxes such as Japan wax, carnauba wax, sugar cane wax, palm wax, candelilla wax and rice wax; mineral-based waxes such as montan wax; and petroleum-based waxes such as paraffin wax, microcrystalline wax and petrolatum. Examples of the synthetic wax include hydrocarbon-based waxes such as Fisher-Tropsch wax and polyolefin wax (for example, polyethylene wax and polypropylene wax). The blended wax is a mixture of the above various waxes. The modified wax is obtained by subjecting the above various waxes to a modification treatment such as oxidation, hydrogenation, alcohol modification, acrylic modification and urethane modification. The wax is preferably at least one selected from the group consisting of microcrystalline wax, Fischer-Tropsch wax, polyolefin wax, paraffin wax and modifications or blends thereof. Among these, a mixture of a plurality of types of wax is more preferable, and a mixture of petroleum-based wax and synthetic wax is particularly preferable. The wax described above has high hydrophobicity, whereas the polyethylene glycol described in Japanese Patent Application Laid-Open No. 2009-214439 has high hydrophilicity. When the ink comes into contact with the transfer body coated with polyethylene glycol, a portion of the polyethylene glycol is dissolved by the liquid component of the ink and the function as a release layer is impaired, so that the transferability is insufficient.

As the wax, a wax that is solid at room temperature (25° C.) is preferable, particularly a wax having a melting point of 40° C. or higher to 120° C. or lower is more preferable and a wax having a melting point of 50° C. or higher to 100° C. or lower is particularly preferable. The melting point of the wax can be measured according to the test method described in 5.3.1 (melting point test method) of JIS K2235: 1991 (petroleum wax). In the case of a mixture of microcrystalline wax, petrolatum and a plurality of waxes, the test method described in 5.3.2 can be used for more accurate measurement. The melting point of wax is easily affected by characteristics such as molecular weight (the larger the value, the higher the melting point), molecular structure (high melting point for straight chain and melting point is lowered for branching), crystallinity (the higher the value, the higher the melting point) and density (the higher the value, the higher the melting point). Therefore, by controlling these characteristics, a wax having a desired melting point can be obtained.

The surface tension S_{W} (mN/m) of the wax is preferably 15 mN/m or more to 40 mN/m or less, more preferably 25 mN/m or more to 40 mN/m or less and particularly preferably 30 mN/m or more to 40 mN/m or less. The surface tension of wax can be measured according to the test method described in JIS K6768: 1999 (plastic film and sheet wet tension test method). Examples of the reagent used in the wet tension test method include a commercially available mixed solution, an organic solvent and a mixed solution of an organic solvent. Specifically, a series of reagents having a gradually increasing surface tension are dropped onto the sample to be measured, the wet state (wet/not wet) is confirmed and the surface tension of the reagent that causes wetting is defined as a surface tension of the sample (mN/m). The surface tension of wax is easily affected by characteristics such as molecular structure (high surface tension for branching and low surface tension for straight chain) and crystallinity (the higher the value, the lower surface tension). Therefore, by controlling these characteristics, it is possible to obtain a wax having a desired surface tension.

At least a portion of the surface of the intermediate image (image) transferred to the recording medium is covered with a wax layer that functions as a release layer. The melting point Tm (° C.) of the wax is preferably 40° C. or higher to 120° C. or lower. By using a wax whose melting point is within the above range, the crack resistance of an obtained recorded material can be improved. The crack resistance of the recorded material means a property that white streaks are unlikely to be formed on an image in a case where the recorded material obtained by recording the image on the recording medium is opened after being bent so that the surface on which the image is recorded is on the inside.

(Reaction Solution)

The recording method of the present disclosure includes a reaction solution applying step of applying an aqueous reaction solution containing a reaction agent that reacts with an aqueous ink to a transfer body. Hereinafter, each component used in the reaction solution will be described in detail.

[Reaction Agent]

The reaction solution contains a reaction agent that reacts with the ink when the reaction agent comes into contact with the ink and aggregates the components (components having anionic groups such as resin and self-dispersion pigment) in the ink. Examples of the reaction agent include a cationic component such as a polyvalent metal ion and a cationic resin; and an organic acid. Among these, the reaction agent is preferably an organic acid, and more preferably a divalent or higher polyvalent carboxylic acid (which may be a salt or a hydrogen salt).

Examples of the polyvalent metal ion include divalent metal ions such as Ca²⁺, Cu²⁺, Ni²⁺, Mg²⁺, Sr²⁺, Ba²⁺ and Zn²⁺, and trivalent metal ions such as Fe³⁺, Cr³⁺, Y³⁺ and Al³⁺. In order to contain the polyvalent metal ion in the reaction solution, a polyvalent metal salt (which may be a hydrate) formed by bonding the polyvalent metal ion and the anion can be used. Examples of anions include inorganic anions such as Cl⁻, Br⁻, I⁻, ClO⁻, ClO₂⁻, ClO₃⁻, ClO₄⁻, NO₂⁻, NO₃⁻, SO₄²⁻, CO₃²⁻, HCO₃⁻, PO₄³⁻, HPO₄²⁻ and H₂PO₄⁻; and organic anions such as HCOO⁻, (COO⁻)₂, COOH(COO⁻), CH₃COO⁻, C₂H₄(COO⁻)₂, C₆H₅COO⁻, C₆H₄(COO⁻)₂ and CH₃SO₃⁻. In a case where polyvalent metal ions are used as the reaction agent, the content (% by mass) in terms of polyvalent metal salt in the reaction solution is preferably 1.0% by mass or more to 20.0% by mass or less based on the total mass of the reaction solution.

The reaction solution containing an organic acid is a solution that efficiently converts the anionic groups of the components present in the ink into acid types and aggregates the anionic groups by having a buffering capacity in an acidic region (pH less than 7.0 and preferably pH 2.0 to 5.0). Examples of organic acids include monocarboxylic acids such as formic acid, acetic acid, propionic acid, butyric acid, benzoic acid, glycolic acid, lactic acid, salicylic acid, pyrrolcarboxylic acid, furancarboxylic acid, picolinic acid, nicotinic acid, thiophencarboxylic acid, levulinic acid, coumalic acid and salts thereof; dicarboxylic acids such as oxalic acid, malonic acid, succinic acid, glutaric acid, adipic acid, maleic acid, fumaric acid, itaconic acid, sebacic acid, phthalic acid, malic acid, tartaric acid and salts thereof and hydrogen salts; tricarboxylic acids such as citric acid and trimellitic acid and salts thereof and hydrogen salts; and tetracarboxylic acid such as pyromellitic acid and salt thereof and hydrogen salt. The content (% by mass) of the organic acid in the reaction solution is preferably 1.0% by mass or more to 50.0% by mass or less based on the total mass of the reaction solution.

Examples of the cationic resin include a resin having a structure of primary to tertiary amines and a resin having a structure of a quaternary ammonium salt. Specific examples thereof include resins having structures such as vinylamine, allylamine, vinylimidazole, vinylpyridine, dimethylaminoethyl methacrylate, ethyleneimine and guanidine. In order to increase the solubility in the reaction solution, the cationic resin and the acidic compound can be used in combination, or the cationic resin can be subjected to a quaternization treatment. In a case where a cationic resin is used as the reaction agent, the content (% by mass) of the cationic resin in the reaction solution is preferably 1.0% by mass or more to 10.0% by mass or less based on the total mass of the reaction solution.

[Other Components]

The reaction solution may contain other components other than the reaction agent, if necessary. Examples of other components include the same components as resins, aqueous media and other additives described below that can be contained in the ink.

(Ink)

The ink used in the recording method of the present disclosure is preferably an aqueous ink for inkjet containing a coloring material. Hereinafter, each component used in the ink will be described in detail.

[Coloring Material]

A pigment and a dye can be used as a coloring material to be contained in the ink. The content (% by mass) of the coloring material in the ink is preferably 0.5% by mass or more to 15.0% by mass or less, and more preferably 1.0% by mass or more to 10.0% by mass or less, based on the total mass of the ink.

Specific examples of the pigment include inorganic pigments such as carbon black and titanium oxide; and organic pigments such as azo, phthalocyanine, quinacridone, isoindolinone, imidazolone, diketopyrrolopyrrole and dioxazine.

As a pigment dispersion method, a resin-dispersion pigment using a resin as a dispersant and a self-dispersion pigment in which a hydrophilic group is bonded to the particle surface of the pigment can be used. In addition, a resin-bonded pigment in which an organic group containing a resin is chemically bonded to the surface of the pigment particles and a microcapsule pigment in which the surfaces of the pigment particles are coated with the resins can be used. Among these, it is preferable to use the resin-dispersion pigment in which the resin as the dispersant is physically adsorbed on the particle surface of the pigment, instead of the resin-bonded pigment or the microcapsule pigment.

As the resin dispersant for dispersing the pigment in the aqueous medium, it is preferable to use a resin dispersant capable of dispersing the pigment in the aqueous medium by the action of an anionic group. As the resin dispersant, a resin as described later, particularly a water-soluble resin can be used. The content (% by mass) of the pigment in the ink is preferably 0.3 times or more to 10.0 times or less in terms of the mass ratio with respect to the content of the resin dispersant.

As the self-dispersion pigment, one in which anionic groups such as a carboxylic acid group, a sulfonic acid group and a phosphonic acid group are bonded to the particle surface of the pigment directly or via another atomic group (—R—) can be used. The anionic group may be either an acid type or a salt type, and in a case where the anionic group is a salt type, the anionic group may be in either a state where a portion thereof is dissociated or a state where the whole thereof is dissociated. In a case where the anionic group is a salt type, examples of the cation that is a counter ion include alkali metal cation, ammonium and organic ammonium. Specific examples of the other atomic group (—R—) include a linear or branched alkylene group having 1 to 12 carbon atoms; an arylene group such as a phenylene group or a naphthylene group; a carbonyl group; an imino group; an amide group; a sulfonyl group; an ester group; and an ether group. In addition, specific examples may be a group in which these groups are combined.

As the dye, it is preferable to use a dye having an anionic group. Specific examples of the dye include dyes such as azo, triphenylmethane, (aza) phthalocyanine, xanthene and anthrapyridone. The coloring material contained in the ink used in the recording method of the present disclosure is preferably a pigment, and more preferably a resin-dispersion pigment.

[Resin]

The ink can contain a resin. The content (% by mass) of the resin in the ink is preferably 0.1% by mass or more to 20.0% by mass or less, and more preferably 0.5% by mass or more to 15.0% by mass or less, based on the total mass of the ink.

The resin can be added to the ink (i) in order to stabilize the dispersed state of the pigment, that is, as one of a resin dispersant and an auxiliary thereof. In addition, the resin can be added to the ink (ii) in order to improve various characteristics of the recorded image. Examples of the form of the resin include block copolymers, random copolymers, graft copolymers and combinations thereof. In addition, the resin may be a water-soluble resin that can be dissolved in an aqueous medium, and may be resin particles dispersed in the aqueous medium. The resin particles do not need to contain a coloring material.

In the present specification, the description that “the resin is water-soluble” means that in a case where the resin is neutralized with an acid value and an equivalent amount of alkali, the resin is present in an aqueous medium in a state where the particles whose particle size can be measured by a dynamic light scattering method are not formed. Whether or not the resin is water-soluble can be determined according to a method illustrated below. First, a liquid (resin solid content: 10% by mass) containing a resin neutralized with an alkali (sodium hydroxide and potassium hydroxide) equivalent to an acid value is prepared. Next, the prepared liquid is diluted 10 times (volume basis) with pure water to prepare a sample solution. In a case where the particle size of the resin in the sample solution is measured by the dynamic light scattering method, and the particles having the particle size are not measured, it can be determined that the resin is water-soluble. The measurement conditions at this time can be, for example, as follows.

[Measurement Condition]

Set Zero: 30 seconds

Number of measurements: 3 times

Measurement time: 180 seconds

As a particle size distribution measuring device, a particle size analyzer (for example, trade name “UPA-EX150”, manufactured by Nikkiso Co., Ltd.) by a dynamic light scattering method can be used. As a matter of course, the particle size distribution measuring device and the measuring conditions to be used are not limited to the above.

An acid value of the water-soluble resin is preferably 100 mgKOH/g or more to 250 mgKOH/g or less. An acid value of the resin constituting the resin particles is preferably 5 mgKOH/g or more to 100 mgKOH/g or less. A weight average molecular weight of the water-soluble resin is preferably 3,000 or more to 15,000 or less. A weight average molecular weight of the resin constituting the resin particles is preferably 1,000 or more to 2,000,000 or less. A volume average particle diameter of the resin particles measured by the dynamic light scattering method is preferably 50 nm or more to 500 nm or less.

Examples of the resin include acrylic-based resins, urethane-based resins and olefin-based resins. Among these, acrylic-based resins and urethane resins are preferable, and acrylic-based resins made of units derived from (meth) acrylic acid and (meth) acrylate are more preferable.

As the acrylic-based resin, a resin having a hydrophilic unit and a hydrophobic unit as constituent units is preferable. Among these, a resin having a hydrophilic unit derived from (meth) acrylic acid and a hydrophobic unit derived from at least one of a monomer having an aromatic ring and a (meth) acrylic acid ester-based monomer is preferable. In particular, a resin having a hydrophilic unit derived from (meth) acrylic acid and a hydrophobic unit derived from at least one monomer of styrene and α-methylstyrene is preferable. Since these resins are likely to interact with pigments, these resins can be suitably used as resin dispersants for dispersing pigments.

The hydrophilic unit is a unit having a hydrophilic group such as an anionic group. The hydrophilic unit can be formed, for example, by polymerizing a hydrophilic monomer having a hydrophilic group. Specific examples of the hydrophilic monomer having a hydrophilic group include an acidic monomer having a carboxylic acid group such as (meth) acrylic acid, itaconic acid, maleic acid and fumaric acid, anionic monomers such as anhydrides and salts of these acidic monomers. Examples of the cation constituting the salt of the acidic monomer include ions such as lithium, sodium, potassium, ammonium and organic ammonium. A hydrophobic unit is a unit that does not have a hydrophilic group such as an anionic group. The hydrophobic unit can be formed, for example, by polymerizing a hydrophobic monomer having no hydrophilic group such as an anionic group. Specific examples of the hydrophobic monomer include monomers having an aromatic ring such as styrene, α-methylstyrene and benzyl (meth) acrylate; and (meth) acrylate-based monomers such as methyl (meth) acrylate, butyl (meth) acrylate and 2-ethylhexyl (meth) acrylate.

The urethane-based resin can be obtained, for example, by reacting a polyisocyanate with a polyol. In addition, the urethane-based resin may be a one obtained by further reacting a chain extender. Examples of the olefin-based resin include polyethylene and polypropylene.

[Aqueous Medium]

The ink used in the recording method of the present disclosure is an aqueous ink containing at least water as an aqueous medium. The ink may contain one of water and an aqueous medium which is a mixed solvent of water and a water-soluble organic solvent. As the water, it is preferable to use one of deionized water and ion-exchanged water. The water content (% by mass) in the aqueous ink is preferably 50.0% by mass or more to 95.0% by mass or less based on the total mass of the ink. In addition, the content (% by mass) of the water-soluble organic solvent in the aqueous ink is preferably 3.0% by mass or more to 50.0% by mass or less based on the total mass of the ink. As the water-soluble organic solvent, any solvent that can be used for inkjet inks such as alcohols, (poly) alkylene glycols, glycol ethers, nitrogen-containing compounds and sulfur-containing compounds can be used.

[Other Additives]

In addition to the above components, the ink may contain various additives such as defoamers, surfactants, pH adjusters, viscosity regulators, rust inhibitors, preservatives, an antifungal agent, an antioxidant and an antireductant, if necessary. However, it is preferable that the ink does not contain the reaction agent used in the reaction solution as described above. In a case where the reaction agent is contained in the ink, the content of the reaction agent in the ink is significantly small (for example, approximately 0.05% by mass or less).

(Transfer Accelerating Solution)

In the intermediate image forming step, it is preferable that after the aqueous ink is applied to the transfer body, an intermediate image is formed by further applying an aqueous transfer accelerating solution to the transfer body in the region to which the aqueous ink of the transfer body is applied. The transfer accelerating solution is preferably ejected from the inkjet recording head. When the transfer accelerating solution is applied to the transfer body, the formed intermediate image has a layer structure in which a reaction solution layer, an ink layer, and a transfer accelerating solution layer are laminated in this order from the transfer body side toward the surface. By forming the transfer accelerating solution layer on the outermost surface of the intermediate image, the adhesiveness of the intermediate image to the recording medium can be enhanced, and the transferability can be further improved. The transfer accelerating solution does not need to contain one of a “reaction agent” to be contained in the reaction solution and a “coloring material” to be contained in the ink. Hereinafter, each component used in the transfer accelerating solution will be described in detail.

[Resin Particles]

[1] Rosin Particles

It is preferable that the transfer accelerating solution contains resin particles. As the resin particles, it is preferable to use rosin particles formed of rosin ester resin. Since the rosin particles have a tack property, the adhesiveness of the intermediate image to the recording medium can be further enhanced by using the transfer accelerating solution containing the rosin particles. The content (% by mass) of the rosin particles in the ink is preferably 1.0% by mass or more to 5.0% by mass or less based on the total mass of the transfer accelerating solution.

The rosin ester resin is a compound obtained by esterifying rosins with alcohols or glycols. Examples of rosins include raw material rosins such as gum rosin, wood rosin and tall rosin; disproportionated products of these raw material rosins; hydrides of these raw material rosins; and polymerized rosins. Examples of alcohols include alkyl (poly) all. Among these, a polyhydric alcohol having a divalent value or higher is preferable. As the glycols, (poly) alkylene glycol is preferable. The rosin ester resin is emulsified by an emulsifier such as a surfactant and an acrylic-based resin, and is present in the ink in the form of rosin particles.

[2] Resin Particles Other than Rosin Particles

The transfer accelerating solution can contain resin particles other than rosin particles. As the resin constituting the resin particles, the above-described resin that can be contained in the ink can be used. Among these, acrylic-based resins and urethane-based resins are preferable, and acrylic-based resins having units derived from (meth) acrylic acid and (meth) acrylate are more preferable. From the viewpoint of improving transferability, the glass transition temperature Tg (° C.) of the resin particles is preferably 0° C. or higher to 180° C. or lower, more preferably 30° C. or higher to 140° C. or lower and particularly preferably 30° C. or higher to 60° C. or lower.

The glass transition temperature Tg (° C.) of the resin particles and the melting point Tm (° C.) of the wax preferably satisfy the relationship of Tg<Tm. By satisfying the above relationship between the glass transition temperature Tg (° C.) of the resin particles and the melting point Tm (° C.) of the wax, when the intermediate image comes into contact with the recording medium, the transfer accelerating solution layer is more easily deformed than the wax layer. Therefore, even when the recording medium has large unevenness on the surface, the transfer accelerating solution layer is deformed along the surface of the recording medium, and the adhesiveness of the intermediate image can be improved.

The glass transition temperature Tg (° C.) of the resin particles and the surface temperature Tb (° C.) of the transfer body preferably satisfy the relationship of Tg<Tb. By satisfying the above relationship between the glass transition temperature Tg (° C.) of the resin particles and the surface temperature Tb (° C.) of the transfer body, when the intermediate image is separated from the transfer body, the high adhesiveness of the transfer accelerating solution layer to the recording medium is maintained, so that the transferability of the intermediate image can be improved. The highest glass transition temperature Tg (° C.) is adopted as the “glass transition temperature Tg (° C.) of the resin particles” in a case where the transfer accelerating solution contains two or more types of resin particles.

From the viewpoint of improving the crack resistance of the recorded material, the glass transition temperature Tg (° C.) of the resin particles is preferably 30° C. or higher to 60° C. or lower. By using the resin particles whose glass transition temperature is within the above range, the compressive force applied to the ink layer when the recorded material is bent can be reduced by the transfer accelerating solution layer. Furthermore, since the adhesiveness between the recording medium and the ink layer can be improved, the crack resistance of the recorded material can be improved.

[Compound Having Structure Represented by General Formula (3)]

The transfer accelerating solution preferably contains a compound having a structure represented by the following general formula (3).

a-OC₂H₄OₙwₚC₃H₆Oₘx_{q}C₂H₄Oₗb (3)

(In the general formula (3), w and x each independently represent a divalent organic group, and a and b each independently represent a hydrogen atom or a monovalent organic group. n and l each independently represent a number of 1 or more, and n+1 is 2 or more to 300 or less. m represents a number of 1 or more to 70 or less, and p and q each independently represent 0 or 1).

The compound having the structure represented by the general formula (3) is likely to form a hydrogen bond with a component (particularly, water-soluble resin) contained in a transfer accelerating solution. When the compound having the structure represented by the general formula (3) forms a hydrogen bond with another component, the transfer accelerating solution layer is thickened, so that the adhesiveness of the intermediate image can be improved. Examples of the compound having the structure represented by the general formula (3) include ADEKA PLURONIC L31 and ADEKA PLURONIC L34 (above, manufactured by ADEKA Corporation), which are trade names. ADEKA PLURONIC L31 is a compound of a=H, b=H, n=1.5, l=1.5, m=16, p=0, q=0 in the general formula (3). ADEKA PLURONIC L34 is a compound of a=H, b=H, n=7, l=7, m=16, p=0, q=0 in the general formula (3).

[Other Components]

If necessary, the transfer accelerating solution may contain resin particles and other components other than the compound having the structure represented by the general formula (3). Examples of other components include those similar to the resins, the aqueous media and other additives described above that can be contained in the ink.

(Cleaning Solution)

The recording method of the present disclosure may further include a cleaning step of applying an aqueous cleaning solution to the transfer body for cleaning, after transferring an intermediate image to a recording medium. Hereinafter, each component used in the cleaning solution will be described in detail.

[Aqueous Medium]

A cleaning solution is an aqueous liquid containing at least water as an aqueous medium. The cleaning solution may contain one of water and an aqueous medium which is a mixed solvent of water and a water-soluble organic solvent. As the water, it is preferable to use one of deionized water and ion-exchanged water. The content (% by mass) of water in the cleaning solution is preferably 50.0% by mass or more to 95.0% by mass or less based on the total mass of the cleaning solution.

Examples of the water-soluble organic solvent that can be used in the cleaning solution include alcohols, (poly) alkylene glycols, glycol ethers, nitrogen-containing compounds and sulfur-containing compounds. Among these, it is preferable to use a low-polarity solvent typified by polyhydric alcohols and glycol ethers. The content (% by mass) of the water-soluble organic solvent in the cleaning solution is preferably 5.0% by mass or more to 50.0% by mass or less, and more preferably 20.0% by mass or more to 40.0% by mass or less based on the total mass of the cleaning solution.

[Surfactant]

The cleaning solution can contain a surfactant. Examples of the surfactant include various surfactants such as anionic, cationic, amphoteric and nonionic. The content (% by mass) of the surfactant in the cleaning solution is preferably 0.1% by mass or more to 5.0% by mass or less based on the total mass of the cleaning solution.

[Other Components]

The cleaning solution may contain other components other than those described above, if necessary. Examples of other components include those similar to the above-described other additives that can be contained in the ink.

### Examples

Hereinafter, the present disclosure will be described in more detail with reference to Examples and Comparative Examples, and the present disclosure is not limited to the following Examples as long as the gist thereof is not exceeded. Regarding the component amounts, those described as “part” and “%” are based on mass unless otherwise specified.

<Preparation of Wax>

The types of waxes illustrated in Table 1 were prepared. The surface tension S_{w} (mN/m) of the wax was measured in accordance with JIS K6768: 1999 using a wax layer having a thickness of 8 μm formed by applying wax on a film made of polyethylene terephthalate as an object to be measured. As the reagent for measurement, a reagent selected from the following reagents according to the surface tension of the object to be measured was used.
Trade name “Mixed solution for wet tension test” (manufactured by Fujifilm Wako Pure Chemical Industries, Ltd.)
N-Hexane (surface tension 18.4 mN/m)
Ethanol (surface tension 22.6 mN/m)
A mixed solution having a known surface tension obtained by mixing n-hexane and ethanol in a predetermined ratio

The melting point Tm (° C.) of the wax made of a single component was measured according to the test method described in 5.3.1 (melting point test method) of JIS K2235: 1991 (petroleum wax). The melting point of a wax (wax mixture) made of a plurality of components was measured according to the test method described in 5.3.2 of JIS K2235: 1991. The haze value of the wax was measured by using a wax layer having a thickness of 8 μm formed by applying wax on a film made of polyethylene terephthalate as an object to be measured, and using a haze meter in accordance with the test method described in JIS K7136: 2000. As the haze meter, the trade name “NDH2000” (manufactured by Nippon Denshoku Kogyo) was used.

TABLE 1
Type of wax

| | | Surface | Melting |
|---|---|---|---|
| | | tension | point |
| | | SW | Tm |
| Wax | Components of wax | (mn/m) | (° C.) |
| 1 | Microcrystalline wax, Polyethylene wax | 31 | 96 |
| 2 | Microcrystalline wax, Fischer-tropsch wax | 25 | 101 |
| 3 | Microcrystalline wax | 31 | 84 |
| 4 | Fischer-tropsch wax | 31 | 90 |
| 5 | Fischer-tropsch wax, Polyethylene Wax | 30 | 99 |
| 6 | Paraffin wax | 21 | 69 |

<Preparation of Reaction Solution>

Each component (unit: %) illustrated in Table 2 was mixed, sufficiently stirred and thereafter pressure filtration is performed with a cellulose acetate filter (manufactured by Advantec Co., Ltd.) having a pore size of 3.0 μm to prepare each reaction solution. In Table 2, “EMUSTAR6315D” is a trade name of wax particles (melting point 113° C.) made by Nippon Seiro Co., Ltd. “Mega Fvck F444” is a trade name of a surfactant manufactured by DIC Corporation. “Acetyleneol E100” is a trade name of a surfactant manufactured by Kawaken Fine Chemicals Co., Ltd.

TABLE 2
Composition of reaction solution

| | Reaction solution | | |
|---|---|---|---|
| | 1 | 2 | 3 |
| Malic acid | 30.0 | | |
| Calcium nitrate | | 3.0 | |
| Citric acid | | | 20.0 |
| Glycerin | 7.0 | 7.0 | |
| EMUSTAR6315D | | | 5.0 |
| Mega Fvck F444 | 5.0 | 5.0 | |
| Acetyleneol E100 | | | 1.0 |
| Ion-exchanged water | 58.0 | 85.0 | 74.0 |

<Preparation of Pigment Dispersion Solution>

(Pigment Dispersion Solution 1)

A styrene-ethyl acrylate-acrylic acid copolymer (resin 1) having an acid value of 150 mgKOH/g and a weight average molecular weight of 8,000 was prepared. After neutralizing 20.0 parts of resin 1 with potassium hydroxide having an acid value equal to the mole, an appropriate amount of pure water is added, and an aqueous solution of resin 1 having a resin (solid content) content of 20.0% was prepared. 10.0 parts of pigment (carbon black), 15.0 parts of an aqueous solution of resin 1 and 75.0 parts of pure water were mixed to obtain a mixture. The obtained mixture and 200 parts of zirconia beads having 0.3 mm diameter were placed in a batch type vertical sand mill (manufactured by AIMEX Co., Ltd.) and dispersed for 5 hours while cooling with water. After centrifuging to remove coarse particles, pressure filtration was performed with a cellulose acetate filter (manufactured by Advantec Co., Ltd.) having a pore size of 3.0 μm to prepare a pigment dispersion solution 1 having a pigment content of 10.0% and a resin dispersant (resin 1) content of 3.0%.

(Pigment Dispersion Solution 2)

A pigment dispersion solution 2 having a pigment content of 10.0% and a resin dispersant (resin 1) content of 3.0% was prepared in the same procedure as the pigment dispersion solution 1 described above, except that the pigment was changed to C. I. Pigment Blue 15:3.

(Pigment Dispersion Solution 3)

A pigment dispersion solution 3 having a pigment content of 10.0% and a resin dispersant (resin 1) content of 3.0% was prepared in the same procedure as the pigment dispersion solution 1 described above, except that the pigment was changed to C. I. Pigment Red 122.

(Pigment Dispersion Solution 4)

A pigment dispersion solution 4 having a pigment content of 10.0% and a resin dispersant (resin 1) content of 3.0% was prepared in the same procedure as the pigment dispersion solution 1 described above, except that the pigment was changed to C. I. Pigment Yellow 74.

<Preparation of Resin Particles>

18.0 parts of butyl methacrylate, 2.0 parts of a polymerization initiator and 2.0 parts of n-hexadecane were placed in a four-necked flask equipped with a stirrer, a reflux cooling device and a nitrogen gas introduction tube, and the mixture was stirred for 0.5 hours while introducing nitrogen gas. As the polymerization initiator, 2,2′-azobis (2-methylbutyronitrile) was used. Next, 78.0 parts of a 6.0% aqueous solution of an emulsifier (trade name “NIKKOL BC15”, manufactured by Nikko Chemicals Co., Ltd.) was added dropwise, and the mixture was stirred for 0.5 hours to obtain a mixture. After irradiating the mixture with ultrasonic waves for 3 hours using an ultrasonic irradiator to emulsify the mixture, a polymerization reaction was performed at 80° C. for 4 hours in a nitrogen atmosphere. After cooling to 25° C. and filtering, an appropriate amount of pure water was added to prepare an aqueous dispersion solution of resin particles having a resin particle (solid content) content of 40.0%.

<Preparation of Ink>

Each component (unit: %) illustrated in Table 3 was mixed, sufficiently stirred and thereafter pressure filtration is performed with a cellulose acetate filter (manufactured by Advantec Co., Ltd.) having a pore size of 3.0 μm to prepare each ink. In Table 3, “Acetylenol E100” is a trade name of a surfactant manufactured by Kawaken Fine Chemicals Co., Ltd.

TABLE 3
Composition of ink

| | Ink | | | | |
|---|---|---|---|---|---|
| | 1 | 2 | 3 | 4 | 5 |
| Pigment dispersion solution 1 | 40.0 | 40.0 | | | |
| Pigment dispersion solution 2 | | | 40.0 | | |
| Pigment dispersion solution 3 | | | | 40.0 | |
| Pigment dispersion solution 4 | | | | | 40.0 |
| Aqueous dispersion solution | 20.0 | | 20.0 | 20.0 | 20.0 |
| of resin particles | | | | | |
| Glycerin | 7.0 | 7.0 | 7.0 | 7.0 | 7.0 |
| Acetylenol E100 | 0.5 | 0.5 | 0.5 | 0.5 | 0.5 |
| Ion-exchanged water | 32.5 | 52.5 | 32.5 | 32.5 | 32.5 |

<Preparation of Resin Particles for Transfer Accelerating Solution>

(Rosin Particles)

The mixture of each component (unit: part) illustrated in the upper part of Table 4 is heated to 90° C., and irradiated with ultrasonic waves approximately one hour using an ultrasonic irradiator (trade name “S-150D Digital Sonifier”, manufactured by Branson Ultrasonics, Emerson Japan, Ltd.). The ultrasonic irradiation time was controlled so that the average particle size (D50) of the obtained rosin particles was within the range described later. Thereafter, the mixture was cooled to obtain an aqueous dispersion solution of rosin particles having a rosin particle (solid content) content of 25.0%. The average particle size (D50) of the rosin particles in the obtained aqueous dispersion solution was within the range of 250 nm±10%. The rosin particles are formed by adhering an anionic emulsifier to the surface of the rosin ester resin. In Table 4, “Ester gum AT” is a trade name of rosin ester resin manufactured by Arakawa Chemical Industries, Ltd.

TABLE 4
Preparation conditions and characteristics of
aqueous dispersion solution of rosin particles

| | |
|---|---|
| Rosin ester resin (Ester gum AT) (parts) | 22.5 |
| Anionic emulsifier (Sodium stearic acid) (parts) | 2.5 |
| Ion-exchanged water (parts) | 70.0 |
| Content (%) of rosin particles | 25.0 |
| Glass transition temperature Tg (° C.) of rosin particles | −24 |

(Resin Particles 1)

An emulsion was prepared by mixing 24.0 parts of butyl methacrylate, 1.5 parts of methacrylic acid and 0.3 part of a surfactant (“Aqualon KH-5”, manufactured by DKS Co., Ltd.). The solution obtained by mixing 74.0 parts of ion-exchanged water and 0.2 part of potassium persulfate was heated to 75° C., the prepared emulsion was added dropwise over 2 hours under a nitrogen atmosphere to perform a polymerization reaction and the mixture was further stirred for 3 hours. After cooling to room temperature, ion-exchanged water and an aqueous potassium hydroxide solution were added to obtain an aqueous dispersion solution of resin particles 1 having a resin particle (solid content) content of 25.0%. The average particle size (D50) of the resin particles 1 in the obtained aqueous dispersion solution was within the range of 230 nm±10%.

(Resin Particles 2)

An aqueous dispersion solution of resin particles 2 having a resin particle (solid content) content of 25.0% was obtained in the same manner as in the case of resin particles 1 described above, except that butyl methacrylate was changed to ethyl methacrylate. The average particle size (D50) of the resin particles 2 in the obtained aqueous dispersion solution was within the range of 230 nm±10%.

(Measurement of Glass Transition Temperature of Resin Particles)

The aqueous dispersion solution of the resin particles is dried and solidified at 25° C. to prepare a measurement sample, and the glass transition temperature Tg (° C.) of the resin particles was measured using a differential scanning calorimeter (“DSC-Q1000”, manufactured by TA Instruments Japan).

<Preparation of Water-Soluble Resin>

(Water-Soluble Resin 1)

A styrene-ethyl acrylate-acrylic acid copolymer (water-soluble resin 1) having an acid value of 150 mgKOH/g and a weight average molecular weight of 8,000 was prepared. After neutralizing 20.0 parts of water-soluble resin 1 with potassium hydroxide having an acid value equal to the mole, an appropriate amount of pure water is added, and an aqueous solution of water-soluble resin 1 having a resin (solid content) content of 20.0% was prepared.

<Preparation of Transfer Accelerating Solution>

Each component (unit: %) illustrated in the upper part of Table 5 was mixed, sufficiently stirred and thereafter pressure filtration is performed with a cellulose acetate filter (manufactured by Advantec Co., Ltd.) having a pore size of 3.0 μm to prepare each transfer accelerating solution. In Table 5, “ADEKA PLRONIC L31” is a trade name of a nonionic surfactant manufactured by ADEKA Corporation. “Acetyleneol E100” is a trade name of a nonionic surfactant (ethylene oxide adduct of acetylene glycol) manufactured by Kawaken Fine Chemicals Co., Ltd.

TABLE 5
Composition and characteristics of transfer accelerating solution

| | Transfer accelerating solution | | |
|---|---|---|---|
| | 1 | 2 | 3 |
| Aqueous dispersion solution of | 8.0 | | 8.0 |
| rosin particles | | | |
| Aqueous dispersion solution of | 40.0 | 40.0 | |
| resin particles 1 | | | |
| Aqueous dispersion solution of | | | 40.0 |
| resin particles 2 | | | |
| Aqueous solution of water-soluble | 5.0 | 5.0 | 5.0 |
| resin 1 | | | |
| ADEKA PLRONIC L31 | 3.0 | 3.0 | 3.0 |
| Acetylenol E100 | 0.5 | 0.5 | 0.5 |
| Glycerin | 7.0 | 7.0 | 7.0 |
| Ion-exchanged water | 36.5 | 44.5 | 36.5 |
| Content (%) of rosin particles | 2.0 | 0.0 | 2.0 |

<Preparation of Surface Layer for Transfer Body>

(Surface Layer 1)

A mixture was obtained by mixing 98.0 parts of silicone rubber (trade name “KE-12”, manufactured by Shin-Etsu Silicone) and 2.0 parts of carbon black. The obtained mixture was spin-coated on a film made of polyethylene terephthalate having a thickness of 0.05 mm to obtain a sheet-shaped silicone rubber having a thickness of 0.3 mm. The obtained sheet-shaped silicone rubber was used as a surface layer 1.

(Surface Layer 2)

A silane coupling agent and an alkoxysilane were mixed at a molar ratio of 1:1 and heated to reflux to obtain a condensate. As the silane coupling agent, 3-glycidoxypropyltriethoxysilane (trade name “KBE-403”, manufactured by Shin-Etsu Silicone) was used. As the alkoxysilane, methyltriethoxysilane (trade name “KBE-13”, manufactured by Shin-Etsu Silicone) was used. A mixture was prepared by mixing the obtained condensate and a cationic-based photopolymerization initiator (trade name “ADEKA ARCLUS SP150”, manufactured by ADEKA Corporation). An appropriate amount of the prepared mixture was applied to the surface of the surface layer 1 whose affinity was enhanced by subjecting the silicone rubber of the surface layer to plasma treatment. After irradiating with ultraviolet light having an integrated exposure of 5000 mJ/cm² using a high-pressure mercury lamp, heat-curing was performed at 150° C. for 2 hours to obtain a surface layer 2 having a surface layer made of a siloxane-modified resin 1 formed on the silicone rubber. The surface layer 2 is a layer in which a surface layer having a thickness of 0.5 μm formed of the siloxane-modified resin 1 is laminated on an elastic layer formed of silicone rubber.

<Preparation of Liquid Absorbing Member>

The emulsion-polymerized particles of the crystallized fluorine-based resin (polytetrafluoroethylene) were compression-molded and thereafter stretched at a temperature below the melting point to prepare a fibrillated porous layer (first layer). Furthermore, polyethylene and polypropylene were mixed and thereafter stretched by a wet method to prepare a fibrillated porous layer (second layer). In addition, a polyolefin-based non-woven fabric (trade name “HOP60”, manufactured by Hirose Paper Co., Ltd.) was prepared as a third layer. The second layer is thicker than the first layer. In addition, the average pore diameter of the second layer is smaller than the average pore diameter of the first layer. The first layer, the second layer and the third layer were hot-pressure laminated and adhered to obtain a porous layer. An impregnating solution was prepared by mixing 95.0 parts of ethanol and 5.0 parts of water. The porous layer was immersed in the prepared impregnating solution, and the inside of the void was wetted with the impregnating solution. Next, the porous layer was immersed in water and the voids were replaced with water to obtain a liquid absorbing member used for liquid removal.

<Recording Conditions>

The combinations of waxes, reaction solutions, inks and transfer accelerating solutions illustrated in Tables 6-1 and 6-2 were filled in the wax coating device 103, the reaction solution applying device 104 and the ink applying device 105 of the transfer type inkjet recording apparatus 100 having the configuration illustrated in FIGURE, respectively. The temperature at each position of the transfer body 101 (positions illustrated by “E” and “F” in FIGURE) was measured using a radiation thermometer (trade name “IT-545”, manufactured by HORIBA, Ltd.). In Comparative Example 6, the wax was not applied by the wax coating device 103.

A transfer body 101 was prepared by fixing each of the surface layers for the transfer body made of various materials to the surface of a columnar support member 102 formed of an aluminum alloy using a double-sided adhesive tape. The prepared transfer body 101 was rotated and used so that the moving speed of the surface was 0.4 m/sec.

The wax contained in the wax accommodating portion 103a was heated to a temperature of the melting point or higher using a heating mechanism (not illustrated) to melt the wax. The molten wax was supplied to the bar coater as the wax coating member 103b. The wax was coated on the transfer body 101 whose temperature at the position (F) where the wax coating member 103b came into contact was controlled to 80° C. so that a wax layer having a thickness of 1.0 μm was formed. The thickness of the formed wax layer was controlled by controlling the wire diameter and contact pressure of the wax coating member 103b. The thickness of the wax layer formed on the transfer body 101 was measured using a laser microscope (trade name “OPTELICS HYBRID”, manufactured by Lasertec Corporation) equipped with a 50-power objective lens. Specifically, the average value obtained by randomly measuring the height from the surface of the transfer body 101 to the surface of the wax layer at four points was calculated and used as the thickness of the wax layer. Until the wax contained in the wax accommodating portion 103a was coated on the transfer body 101, the wax accommodating portion 103a and the wax coating member 103b were kept at a temperature of the melting point or higher of the wax to keep a molten state of the wax. The wax layer was formed over the entire region corresponding to the recording medium on the transfer body 101.

The reaction solution was applied to a wax-applied region of the transfer body 101 so as to be 1.0 g/m² using the reaction solution applying device 104. A recording head of a type that ejects ink by an on-demand method provided with an electric-heat conversion element was used as the ink applying device 105, and the ink was applied to the region of the transfer body 101 to which the reaction solution was applied.

The above-described porous layer was used as the liquid absorbing member 106a. The moving speed of the liquid absorbing member 106a was controlled by controlling the rotating speed of the stretching roller 106c so as to be the same as the rotating speed of the transfer body 101. The moving speed of the liquid absorbing member 106a was 0.4 m/sec. By pressing the liquid absorbing member 106a toward the transfer body 101 using the pressing member 106b so that the nip pressure between the transfer body 101 and the liquid absorbing member 106a is 2 kg/cm², at least a portion of the liquid component was removed from the intermediate image.

An infrared heater was used as the heating device 107, and the heating position (D) of the transfer body 101 was irradiated with infrared rays. As a result, the intermediate image was heated to further remove the liquid component, and the transfer body 101 was heated so that the surface temperature Ta of the transfer body 101 and the temperature of the intermediate image at the position where the intermediate image contacts the recording medium 109 at the transfer position (E) were the temperatures illustrated in Tables 6-1 and 6-2. Furthermore, the temperature of the pressing member 108 was controlled as necessary so that the surface temperature Tb of the transfer body 101 and the temperature of the intermediate image at the position where the intermediate image is separated from the transfer body 101 at the transfer position (E) were the temperatures illustrated in Tables 6-1 and 6-2. The temperature of the pressing member 108 was controlled by using a temperature control device provided on the pressing member 108 capable of heating and cooling.

The recording medium 109 was conveyed by driving the recording medium feeding roller 110a and the recording medium winding roller 110b so as to have a speed equivalent to the rotation speed (0.4 m/sec) of the transfer body 101. The recording medium 109 and the intermediate image were brought into contact with each other between the transfer body 101 and the pressing member 108, and the intermediate image was transferred from the transfer body 101 to the recording medium 109 to record the image. The nip pressure between the transfer body 101 and the pressing member 108 was controlled to 3 kg/cm².

TABLE 6-1
Table 6-1: Evaluation conditions

| | | Example | | | | | | | | | | | | |
|---|---|---|---|---|---|---|---|---|---|---|---|---|---|---|
| | | 1 | 2 | 3 | 4 | 5 | 6 | 7 | 8 | 9 | 10 | 11 | 12 | 13 |
| Transfer body | Type of surface layer | 1 | 1 | 1 | 1 | 1 | 1 | 2 | 1 | 1 | 1 | 1 | 1 | 1 |
| Wax | Type | 1 | 1 | 1 | 1 | 1 | 1 | 1 | 2 | 3 | 4 | 5 | 1 | 1 |
| | Melting point Tm (° C.) | 96 | 96 | 96 | 96 | 96 | 96 | 96 | 101 | 84 | 90 | 99 | 96 | 96 |
| Type of reaction solution | | 1 | 2 | 1 | 1 | 1 | 1 | 1 | 1 | 1 | 1 | 1 | 1 | 1 |
| Type of ink | | 1 | 1 | 2 | 3 | 4 | 5 | 1 | 1 | 1 | 1 | 1 | 1 | 1 |
| Transfer accelerating | Type | 1 | 1 | 1 | 1 | 1 | 1 | 1 | 1 | 1 | 1 | 1 | 1 | 1 |
| solution | Tg (° C.) of resin particles | 60 | 60 | 60 | 60 | 60 | 60 | 60 | 60 | 60 | 60 | 60 | 60 | 60 |
| Other conditions | Surface temperature Ta | 106 | 106 | 106 | 106 | 106 | 106 | 106 | 111 | 94 | 100 | 109 | 101 | 98 |
| | (° C.) of transfer body | | | | | | | | | | | | | |
| | Surface temperature Tb | 76 | 76 | 76 | 76 | 76 | 76 | 76 | 81 | 64 | 70 | 79 | 76 | 76 |
| | (° C.) of transfer body | | | | | | | | | | | | | |
| | Ta − Tm (° C.) | 10 | 10 | 10 | 10 | 10 | 10 | 10 | 10 | 10 | 10 | 10 | 5 | 2 |
| | Tm − Tb (° C.) | 20 | 20 | 20 | 20 | 20 | 20 | 20 | 20 | 20 | 20 | 20 | 20 | 20 |

TABLE 6-2
Table 6-2: Evaluation conditions

| | | Example | | | | | | Comparative Example | | | | | |
|---|---|---|---|---|---|---|---|---|---|---|---|---|---|
| | | 14 | 15 | 16 | 17 | 18 | 19 | 1 | 2 | 3 | 4 | 5 | 6 |
| Transfer body | Type of surface layer | 1 | 1 | 1 | 1 | 1 | 1 | 1 | 1 | 1 | 1 | 1 | 1 |
| Wax | Type | 1 | 1 | 1 | 1 | 3 | 1 | 1 | 1 | 6 | 2 | 1 | — |
| | Melting point Tm (° C.) | 96 | 96 | 96 | 96 | 84 | 96 | 96 | 96 | 69 | 101 | 96 | — |
| Type of reaction solution | | 1 | 1 | 1 | 1 | 1 | 1 | — | 1 | 1 | 1 | 1 | 3 |
| Type of ink | | 1 | 1 | 1 | 1 | 1 | 1 | 1 | 1 | 1 | 1 | 1 | 1 |
| Transfer accelerating | Type | 1 | 1 | — | 2 | 3 | 1 | 1 | 1 | 1 | 1 | 1 | — |
| solution | Tg (° C.) of resin particles | 60 | 60 | — | 60 | 85 | 60 | 60 | 60 | 60 | 60 | 60 | — |
| Other conditions | Surface temperature Ta | 106 | 106 | 106 | 106 | 94 | 106 | 106 | 106 | 106 | 96 | 91 | 106 |
| | (° C.) of transfer body | | | | | | | | | | | | |
| | Surface temperature Tb | 86 | 91 | 76 | 76 | 64 | 55 | 76 | 101 | 76 | 76 | 76 | 76 |
| | (° C.) of transfer body | | | | | | | | | | | | |
| | Ta − Tm (° C.) | 10 | 10 | 10 | 10 | 10 | 10 | 10 | 10 | 37 | −5 | −5 | — |
| | Tm − Tb (° C.) | 10 | 5 | 20 | 20 | 20 | 41 | 20 | −5 | −7 | 25 | 20 | — |

<Evaluation>

Each of the following items was evaluated using the transfer type inkjet recording apparatus 100 (FIGURE) having the above configuration. In this transfer type inkjet recording apparatus 100, an image recorded under the condition that one drop of 3.0 ng ink is applied to a unit region of 1/1,200 inch×1/1,200 inch is defined as a recording duty of 100%. In the present disclosure, “AA”, “A” and “B” are set as acceptable levels and “C” is set as an unacceptable level in the evaluation criteria of the following items. The evaluation results are illustrated in Table 7.

(Image Density)

Using the transfer type inkjet recording apparatus 100 (FIGURE), a solid image of 5 cm×5 cm having a recording duty of 100% was continuously recorded on a recording medium 100 times. As the recording medium, coated paper (trade name “Aurora coated paper”, manufactured by Nippon Paper Industries Co., Ltd.) was used. The density of the image transferred to the recording medium was measured, the average value of the image density was calculated and the image density was evaluated according to the evaluation criteria illustrated below. The image density was measured using a fluorescence spectrophotometer (trade name “FD-7”, manufactured by KONICA MINOLTA, INC.) under the measurement conditions of the “reflection measurement mode”, “M0 (A) illumination”, “observation field of view 2°”, “observation light source D50” and “no polarizing filter attached”. In addition, the evaluation item was measured as “concentration K (STATUS A)”.

AA: The average value of the image density was 2.20 or more.

A: The average value of the image density was 2.15 or more to less than 2.20.

B: The average value of the image density was 2.10 or more to less than 2.15.

C: The average value of the image density was less than 2.10, or a portion of the image transferred to the recording medium was missing, and the accurate image density could not be measured

(Transferability 1)

Using the transfer type inkjet recording apparatus 100 (FIGURE), a solid image of 5 cm×5 cm having a recording duty of 100% was continuously recorded on a recording medium 100 times. Coated paper (trade name “Tanto”, manufactured by Tokushu Tokai Paper Co., Ltd.) was used as the recording medium. The image transferred to the recording medium was visually observed, and the transferability was evaluated according to the evaluation criteria illustrated below.

AA: The density of all the images transferred 100 times was sufficient.

A: Of the images transferred 100 times, the density of the image of 50 or more to 99 or less was sufficient.

B: Of the images transferred 100 times, the density of the image of 10 or more to 49 or less was sufficient.

C: Of the images transferred 100 times, the density of the image of 0 or more to 9 or less was sufficient

(Transferability 2)

For Examples 1 and 16 to 19, images were recorded under the same conditions as in the case of transferability 1 described above, except that the moving speed of the surface of the transfer body 101 was changed from 0.4 m/sec to 1.0 m/sec, and the transferability was evaluated according to the same evaluation criteria.

TABLE 7
Evaluation results

| | | Image | Transferability | Transferability |
|---|---|---|---|---|
| | | density | 1 | 2 |
| Example | 1 | AA | AA | AA |
| | 2 | AA | AA | — |
| | 3 | AA | AA | — |
| | 4 | AA | AA | — |
| | 5 | AA | AA | — |
| | 6 | AA | AA | — |
| | 7 | AA | AA | — |
| | 8 | AA | AA | — |
| | 9 | AA | AA | — |
| | 10 | AA | AA | — |
| | 11 | AA | AA | — |
| | 12 | AA | A | — |
| | 13 | AA | B | — |
| | 14 | A | AA | — |
| | 15 | B | AA | — |
| | 16 | AA | AA | B |
| | 17 | AA | AA | A |
| | 18 | AA | AA | B |
| | 19 | AA | AA | A |
| Comparative | 1 | — | C | — |
| Example | 2 | C | AA | — |
| | 3 | C | AA | — |
| | 4 | — | C | — |
| | 5 | — | C | — |
| | 6 | — | C | — |

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-231393, filed Dec. 23, 2019, which is hereby incorporated by reference herein in its entirety.

What is claimed is:

1. An inkjet recording method of recording an image on a recording medium using an aqueous ink, the method comprising:
coating wax on a transfer body;
applying an aqueous reaction solution containing a reaction agent reacting with the aqueous ink to the transfer body;
forming an intermediate image by applying the aqueous ink to the transfer body; and
transferring the intermediate image by bringing the intermediate image into contact with the recording medium, in this order, wherein
a surface temperature Ta (° C.) of the transfer body at a position where the intermediate image contacts the recording medium, a surface temperature Tb (° C.) of the transfer body at a position where the intermediate image is separated from the transfer body, and a melting point Tm (° C.) of the wax satisfy a relationship of Tb<Tm≤Ta.

2. The inkjet recording method according to claim 1, wherein
the surface temperature Ta (° C.) of the transfer body and the melting point Tm (° C.) of the wax satisfy a relationship of Ta−Tm≥10 (° C.).

3. The inkjet recording method according to claim 1, wherein
the surface temperature Tb (° C.) of the transfer body and the melting point Tm (° C.) of the wax satisfy a relationship of Tm−Tb≥20 (° C.).

4. The inkjet recording method according to claim 1, the method further comprising:
applying an aqueous transfer accelerating solution to a region of the transfer body to which the aqueous ink is applied to form the intermediate image, after applying the aqueous ink to the transfer body.

5. The inkjet recording method according to claim 4, wherein
the transfer accelerating solution contains resin particles.

6. The inkjet recording method according to claim 5, wherein
a glass transition temperature Tg (° C.) of the resin particles and the melting point Tm (° C.) of the wax satisfy a relationship of Tg<Tm.

7. The inkjet recording method according to claim 5, wherein
a glass transition temperature Tg (° C.) of the resin particles and the surface temperature Tb (° C.) of the transfer body satisfy a relationship of Tg<Tb.

8. The inkjet recording method according to claim 5, wherein
the resin particles contain rosin particles.

9. An inkjet recording apparatus used to record an image on a recording medium using an aqueous ink, the apparatus comprising:
a wax coating unit that coats wax on a transfer body;
a reaction solution applying unit that applies an aqueous reaction solution containing a reaction agent reacting with the aqueous ink to the transfer body;
an ink applying unit that forms an intermediate image by ejecting the aqueous ink by an inkjet method and applying the aqueous ink to the transfer body;
a transfer unit that transfers the intermediate image by bringing the intermediate image into contact with the recording medium; and
a temperature control unit that controls a temperature of the transfer body so that a surface temperature Ta (° C.) of the transfer body at a position where the intermediate image contacts the recording medium, a surface temperature Tb (° C.) of the transfer body at a position where the intermediate image is separated from the transfer body, and a melting point Tm (° C.) of the wax satisfy a relationship of Tb<Tm≤Ta.
